(19) United States
(12) Patent Application Publication
(10) Pub. No.: US 2008/0297306 A1
(43) Pub. Date: Dec. 4, 2008

(54) Hardware and Software Activating Device and Methods Thereof

(76) Inventors: Wang Huajun, Mississauga (CA); Ning Shangguo, Shenzhen (CN)

Correspondence Address: MORGAN LEWIS & BOCKIUS LLP, 1111 PENNSYLVANIA AVENUE NW, WASHINGTON, DC, 20004, US

(21) Appl. No.: 12/131,681

(22) Filed: Jun. 2, 2008

(30) Foreign Application Priority Data
May 31, 2007 (CN) 200710074705.8

(51) Int. Cl. G05B 19/00

(52) U.S. Cl. 340/5.51

(57) ABSTRACT

A device for activating independent software and hardware including a communication port of an independent software and hardware activating module for receiving activating guidance information of an independent component, and a control module of the independent hardware and software activating module for generating cluing information according to the activating guidance information, and transmitting the cluing information to a main equipment, the main equipment displaying the cluing information on a screen of the main equipment, and prompting a user to choose between activating methods to gain an activating code, the user gaining the activating code according to a chosen activating method, and entering the activating code into the main equipment, the main equipment transmitting the activating code through the communication port to the control module for verification of the activating code.

The present application claims the benefit of Chinese Patent Application No. CN200710074705.8, filed in China on May 31, 2007, which is incorporated herein by reference.

### BACKGROUND OF THE INVENTION

1. Field of the Invention

The present invention relates to television. More specifically, the present invention relates to a hardware and software activating device and the methods thereof.

2. Discussion of the Related Art

With the development of technology, apart from the traditional ways such as television, set-top-box, etc., people can watch television programs through some newly invented devices like television card, mobile phone with television, and so on. As the combination of internet, TV net and telecommunication net accelerates its development, the application of television is also greatly broadened. Thus, it inevitably becomes popular to preinstall television function in many types of electronic equipment, the necessary hardware and software of which will need to be offered to the user. In doing so, concerns arise, such as how the hardware and software should be offered, and how the providers involved should be protected, especially those who provide the technology to profit from the user. Considering the development of the market where specialization becomes a trend, technology providers, equipment manufacturers, and software providers will specialize in their own businesses, each offering respective services, bearing risks, and gaining profits.

At present, there are two types of digital television. One kind of digital television is an ordinary television with an additional television set-top box. Another kind of the digital television is an integrated digital machine. The ordinary television with additional television set-top box is a transitional measure for the current situation, and the integrated digital machine will be the direction of the digital television.

An integrated digital machine is shown in FIG. 1, including: tuner 11, demodulator 12 to receive the amplified IF signal from tuner 11, TS demultiplexer 13, MPEG-2 decoder 15, image and voice processor 16, image and voice output module 17, and the external output modules including PAL/NTSC encoder 14, external video output 18 and external audio output 19. The integrated digital machine also includes a MCU (Micro Chip Unit) 20 to receive remote controlling signals from the remote controller 2 and to control the tuner 11, demodulator 12, TS demultiplexer 13, MPEG-2 decoder 15, image and voice processor 16, image and voice output module 17, PAL/NTSC encoder 14, external video output 18, external audio output 19, and E2PROM 21 through the I2C bus (not shown). The difference in transmission standards of the digital television is the difference of tuners. Different transmission standards require different tuners.

An ordinary television with an additional television set-top box (STB) is shown in FIG. 2. The STB 3 includes tuner 31, demodulator 32 to receive the amplified IF signal from tuner 31, TS demultiplexer 33, MPEG-2 decoder 34, PAL/NTSC encoder 35, video output 36, and audio output 37. The STB also includes a MCU (Micro Chip Unit) 38 to receive remote controlling signals from the remote controller 30 and to control the tuner 31, demodulator 32, TS demultiplexer 33, MPEG-2 decoder 34, PAL/NTSC encoder 35, video output 36, audio output 37 and E2PROM 301 through the I2C bus (not shown). The difference in transmission standards of the digital television is the difference of tuners and demodulators. Different transmission standards require different tuners and demodulators. The broadcast device 4 includes image and voice processing module 43, image and voice output module 44, E2PROM 40, MCU 41 and remote controlling sending and receiving pre-processing module 42. Through the remote controlling sending and receiving pre-processing module 42, MCU 41 receives remote controlling signals from the remote controller 5 to control the image and voice processing module 43, image and voice output modules 44 and the E2PROM 40 through the I2C bus (not shown).

Several modes are illustrated in the above-mentioned figures. In the mode of FIG. 1, all the hardware and software are provided by the equipment manufacturers, with high cost and risk. In the mode of FIG. 2, the cost will be slightly lowered since different equipment and its corresponding software can be offered by different manufacturers, and accordingly, the risk will be slightly lowered as well. In television sets, there are increasing amounts of hardware and software, the application of which will involve different standards, the patents of which are not owned by the manufacturers. If the manufacturers integrate these hardware and software into their television sets and provide them directly to the user, they risk infringing the patents of these hardware and software. Also, many of these integrated functions (realized by corresponding hardware and software) have no actual value. For example, consider a high frequency tuner, which is installed in a television set to receive terrestrial broadcast signals. To the user who purchases cable television signals, the high frequency tuner, whose cost together with that of corresponding software adds to the purchase cost for the user, and which increases the chances of infringement for the manufacturer, is useless. In another example, the hardware and software integrated into cell phones and other equipment may be not necessary for some users. Therefore, it is feasible that hardware and software which may or may not be used can be pre-integrated into television sets or other equipment, but certain conditions are set up by the manufacturers of television sets or other equipment to prevent the user from employing such hardware and software. If the need for such hardware and software arises, the user needs to obtain, by himself, a corresponding license before the software and hardware can be used. Alternatively, manufacturers provide a list of optional hardware and software from which the user can choose upon purchase of equipment, or when it is needed. Here, the user purchases the separate hardware and gains permission before use in a television set produced by the manufacturer. The problem of how to achieve user access to software and hardware licenses is presented above. Technology allowing the use of these hardware and software which enable the user to receive television programs is not yet available.

### SUMMARY OF THE INVENTION

Accordingly, the present invention is directed to a hardware and software activating device and the methods thereof that substantially obviates one or more problems due to limitations and disadvantages of the related art.

An object of the present invention is to provide a device capable of activating hardware and software associated with a television.

Another object of the present invention is to provide a method capable of activating hardware and software associated with a television.

Additional features and advantages of the invention will be set forth in the description which follows and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the device for activating independent software and hardware includes a communication port of an independent software and hardware activating module for receiving activating guidance information of an independent component, and a control module of the independent hardware and software activating module for generating cluing information according to the activating guidance information, and transmitting the cluing information to a main equipment, the main equipment displaying the cluing information on a screen of the main equipment, and prompting a user to choose between activating methods to gain an activating code, the user gaining the activating code according to a chosen activating method, and entering the activating code into the main equipment, the main equipment transmitting the activating code through the communication port to the control module for verification of the activating code.

In another aspect, the method for activating independent software and hardware includes at least the steps of receiving activation guidance information of an independent component at a communications port of an independent software and hardware activating module, generating cluing information according to the activating guidance information at a control module of the independent hardware and software activating module, transmitting the cluing information to a main equipment, the cluing information being displayed on a screen of the main equipment, prompting a user at the main equipment to choose between activating methods to gain an activating code, prompting a user at the main equipment for the activating code, transmitting the activating code from the main equipment to the control module through the communication port, and verifying the activating code at the control module.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a diagram of an integrated digital machine according to the related art;

FIG. 2 is a diagram of an ordinary television with an additional television set-top box according to the related art;

FIG. 3 is diagram of an exemplary independent television signal receiving device and broadcast device according to the present invention;

FIG. 4 is a diagram of an exemplary activating device according to the present invention;

FIG. 5 is a diagram of an exemplary activation module according to the present invention; and

FIG. 6 is a diagram of an exemplary activating method according to the present invention.

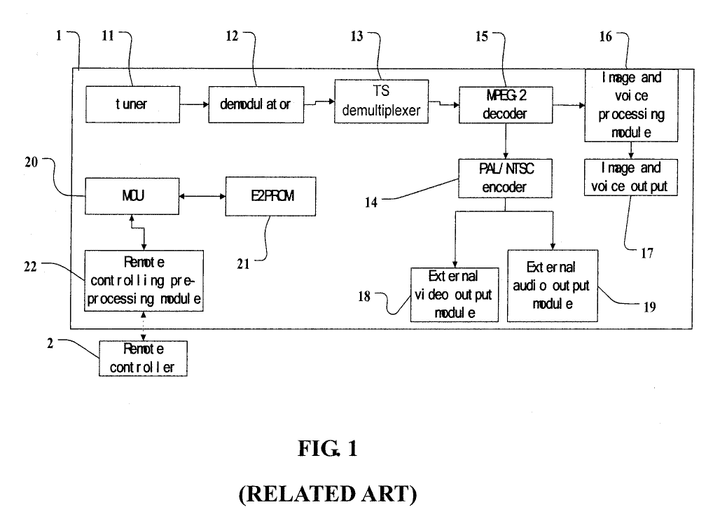

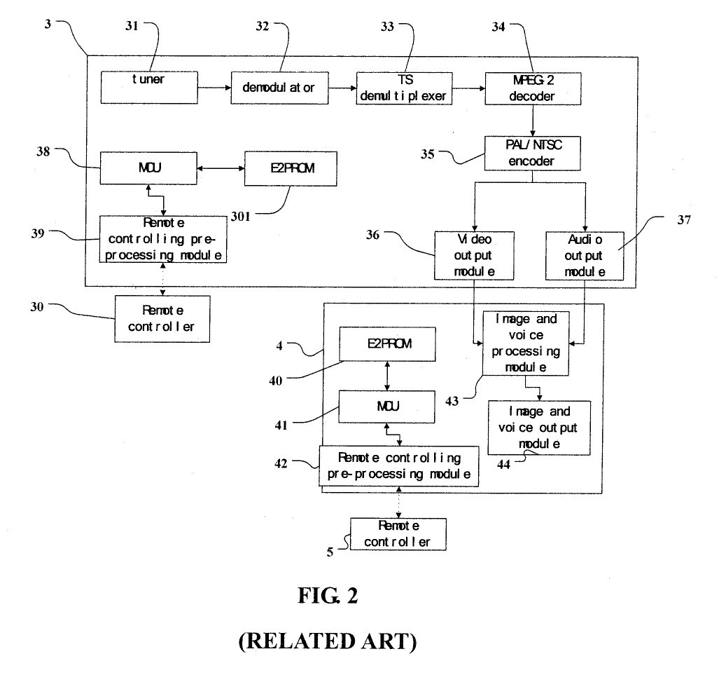

### DETAILED DESCRIPTION OF THE PREFERRED EMBODIMENTS

Reference will now be made in detail to the illustrated embodiments of the present invention, which are illustrated in the accompanying drawings.

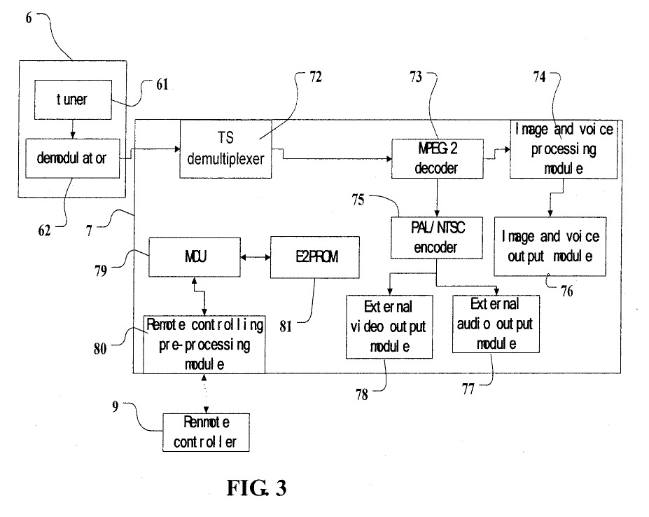

As described above, the high frequency tuner in a television set is not necessary for every user. In this embodiment, the signal receiving device parts of the television are separated. Referring to FIG. 3, the television without signal tuning and demodulating part (hereinafter referred to as broadcast device 7) includes TS demultiplexer 73, MPEG-2 decoders 72, image and voice processor 74, image and voice output module 76, and the external output modules, including PAL/NTSC encoder 75, external video output module 78, and external audio output module 77.

Through remote controlling processing module 80, MCU 79 receives remote control signals sent by remote controller 9. In addition, MCU 79 controls TS demultiplexer 72 through I2C bus (not shown), MPEG-2 decoders 73, image and voice processor 74, image and voice output module 76, PAL/NTSC encoder 75, external video output module 78, external audio output module 77, and EEPROM 81.

A television signal receiving device is shown as the signal receiving device 6 in FIG. 3, including the tuner 61 and demodulator 62. The tuner 61 is used for the reception of television signals transmitted by terrestrial broadcasting or satellites and for the frequency conversion and filtering of the RF signals. The demodulator 62 is used for the demodulation of the television signals received by the tuner 61.

In this embodiment, the tuner 61 and demodulator 62 together constitute an independent television signal receiving device 6. Televisions manufactured by television manufacturers can only be broadcast device 7 without signal tuning and demodulating parts, i.e., not including a television signal receiving device 6, as shown in FIG. 3.

For some users that need to use the television signal receiving device 6 to receive wireless signals, they can purchase an independent television signal receiving device 6 to support the use of broadcast device 7. But before use of the television signal receiving device 6, it needs to be activated.

In addition to the television signal receiving device 6, other hardware can also be separated from the television. Such hardware can be purchased by the user and installed into the television set, or be pre-installed by a television manufacturer in the television. In the latter case, the user will have to activate the pre-installed hardware when he wants to use it, the aim of activation being to obtain permission from the owner of the relevant patents by the user himself (those hardware separated from the television set hereinafter referred to as independent hardware). In this embodiment, the hardware separated from the television set is exemplified by the television signal receiving device 6. In the application of the present invention to other independent hardware, the principles are basically the same.

As for the now existing television sets, more and more functions, which are often achieved by the integration of software in the television set, or by the cooperation between specific software and hardware, are provided. But many of the functions may never be used by the user. Therefore, another option is provided in this invention, i.e., a television manufacturer's pre-integrated functional software (hereinafter referred to as independent software) into the television set. If the user needs to use such a function, the user must first activate the software, and then normal use of the function can be realized.

In addition to the pre-integrated software in television sets, the software integrated into the independent hardware mentioned above also applies to the present invention, such as the middleware in the television signal receiving device 6. In other words, the above-mentioned television signal receiving device 6 can be used only after the software and hardware are activated. In certain circumstances, the activation of software and hardware can be completed at one time. Similarly, the activation of television functions in other equipment, such as a mobile phone, applies to the present invention as well. The software applicable to the present invention includes relevant software required for television receiving, operational control, or additional functions.

Here, the main parts of the television set (not including independent hardware and software, which may have been pre-integrated into the television set, or which may not have been integrated and the user needs to purchase separately, their common feature being that an activation operation is needed before the normal use of them) and other equipment with television software and hardware integrated (such as cell phones with an integrated television function) are collectively referred to as the main equipment. The hardware and software which need to be activated for normal use will be known collectively as independent hardware and software.

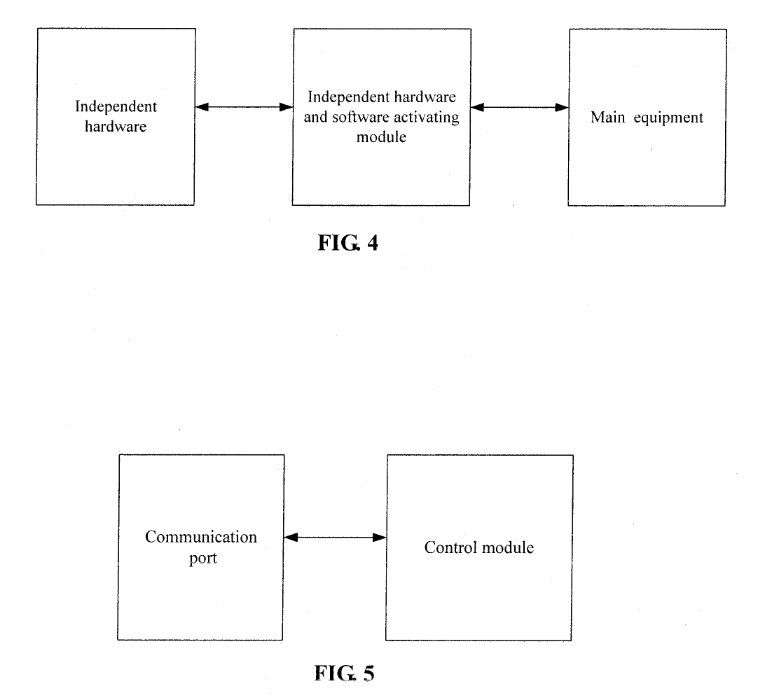

An activating device according to the invention is shown in FIG. 4. The activating device includes independent hardware (shown in FIG. 3 as a signal receiving device 6), independent software and hardware activating module, and main equipment (shown in FIG. 3 as broadcast device 7). The independent hardware, as the above-mentioned signal receiving device 6, is designed to receive and to demodulate the broadcast television signal, then to transmit TS to the broadcast device 7. The main equipment, broadcast device 7, is used to receive TS transmitted by signal receiving device 6 and process it, then output audio and video information. Independent hardware and software activating module will activate the independent hardware, signal receiving device 6, when signal receiving device 6 is connected for the first time to broadcast device 7. The independent hardware and software activation module can be installed in the signal receiving device 6 or broadcast device 7, or even set up separately.

The block diagram of the independent software and hardware activation module is shown in FIG. 5, including a communication port and a control module. The communication port is designed mainly to obtain activating guidance information from the signal receiving device 6, and to be used as channels for transferring information between broadcast device 7 and the control module.

The control module is mainly used to generate cluing information of activating procedures to guide the user as to how to activate the hardware according to the activating guidance information received from receiving device 6. The cluing information of activating procedures is sent to the main equipment through the communication port and displayed to guide the activation operation of the user. In addition, the control module is also used to verify whether the user's activation operation is correct or not and control the functioning of independent hardware (signal receiving device 6) according to the test results.

Before activation, the tuners, the modems and the TS demultiplexer of television signal receiving device 6 cannot work normally in the following ways: completely being unable to work, scrambling signal (users seeing images of low resolution), or intermittent working (users being unable to obtain continuous sound or image), or the hardware being accessible with no charge only for a period of time, and when the free period expires, the television signal receiving device 6 will not work.

The concrete process of the activation operation can be carried out with a variety of methods. The method adopted in this embodiment of the invention is as follows. The independent software and hardware activating module obtains activating guidance information (including hardware and equipment manufacturers, equipment identification numbers which is given by the hardware manufacturers and only identifies the equipment, corresponding network activating methods or telephone activating methods, and other relevant information) from the signal receiving device 6 through the communication port. The control module generates cluing information of activating procedures according to the activating guidance information, then transmits and displays it on the screen of the television set.

First, device manufacturers and equipment identification numbers are displayed on the screen of the main equipment, then activating methods prompt the user to choose between network activating methods or telephone activating methods. Next, the approaches to gain an activating code are shown according to the activating method selected by the user. After the user gets the activating code through network or telephone, broadcast device 7 will prompt the user to enter the activating code which will be transmitted to the control module of the independent software and hardware activating module and verified by it. If the activating code is verified, the control module will instruct signal receiving device 6 to work normally.

The control module in the independent software and hardware module can control the hardware in signal receiving device 6 in the following manner. The independent software and hardware module receives encrypted TS transmitted by the signal receiving device 6, and decrypts it according to the activating code the user enters before it is transmitted to the broadcast device 7. If the control module fails to receive the activating code, or receives an incorrect activating code, it cannot decrypt the TS signal, thus the broadcast device 7 cannot process the TS signal normally.

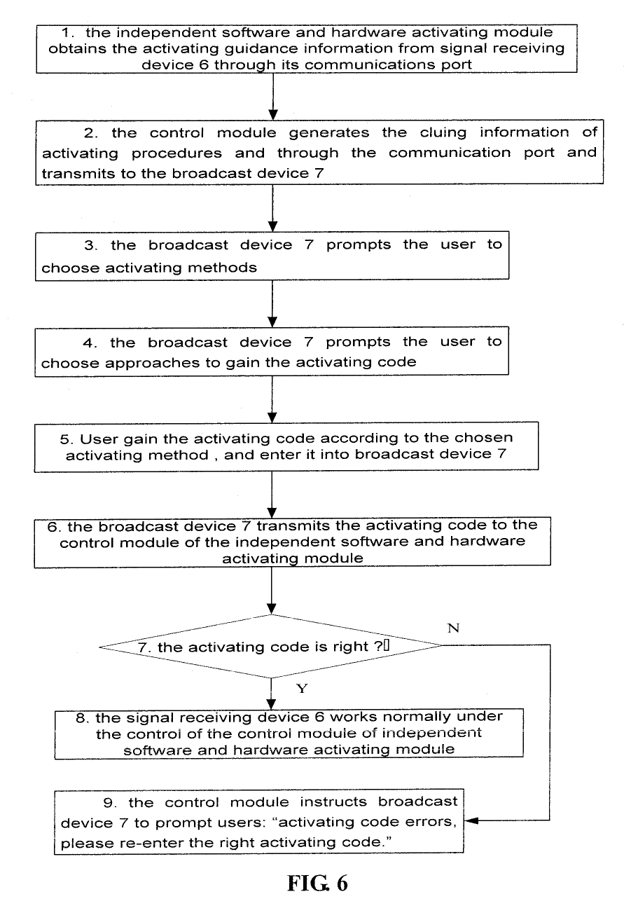

The procedure of activating the independent software and hardware is shown in FIG. 6, including the following steps:

1. The independent software and hardware activating module obtains the activating guidance information from signal receiving device 6 through its communications port.

2. The control module of the independent hardware and software activating module generates the cluing information of activating procedures according to the activating guidance information, and through the communication port, transmits to the broadcast device 7 the cluing information of activating procedures which will be displayed on the screen, equipment manufacturers and equipment identification number being shown first.

3. The broadcast device 7 prompts the user to choose between activating methods that include network activating methods or telephone activating methods;

4. The broadcast device 7 prompts the user to choose approaches to gain the activating code.

5. The user gains the activating code according to the chosen activating method, and enters it into broadcast device 7.

6. Through the communication port, the broadcast device 7 transmits the activating code to the control module of the independent software and hardware activating module.

7. The control module of the independent software and hardware activating module verifies the activating code. If the activating code is right, the user goes on with step 8, otherwise, the user goes on to step 9.

8. The signal receiving device 6 works normally under the control of the control module of independent software and hardware activating module.

9. The control module of independent software and hardware activating module instructs the broadcast device 7 to prompt the user: “activating code errors, please re-enter the right activating code.”

The above embodiment explains the activating process of the independent hardware of a television set. As for independent software, it can also be activated through the operation of the independent hardware and software activation device as described above. When users need to use the corresponding function of certain independent software, the television set judges that realizing the function requires activating this software, and the activating guidance information carried by this software will be transmitted to the independent software and hardware activating device, and then sent to the television set through the communication port. Then, the television set will generate a menu of activating procedures according to the activating guidance information, displaying it to users on the screen for them to follow.

To prevent the software or hardware from illegal use, the identification numbers of the software and hardware are encrypted. And the encrypted identification numbers and their activating codes correspond to each other, both of which are necessary for users to activate the software and hardware.

Using the above method, the parties involved in television are free to choose their own way to gain profits. For example, making profits by inserting advertisements in the software and hardware.

It will be apparent to those skilled in the art that various modifications and variations can be made to the present invention without departing from the spirit or scope of the invention. Thus, it is intended that the present invention cover the modifications and variations of this invention provided they come within the scope of the appended claims and their equivalents.

What is claimed is:

1. A method for activating independent software and hardware comprising at least the steps of:
receiving activation guidance information of an independent component at a communications port of an independent software and hardware activating module;
generating cluing information according to the activating guidance information at a control module of the independent hardware and software activating module;
transmitting the cluing information to a main equipment, the cluing information being displayed on a screen of the main equipment;
prompting a user at the main equipment to choose between activating methods to gain an activating code;
prompting a user at the main equipment for the activating code;
transmitting the activating code from the main equipment to the control module through the communication port; and
verifying the activating code at the control module.

2. The method according to claim 1, wherein the independent component is a signal receiving device.

3. The method according to claim 1 wherein the cluing information includes an equipment manufacturer and an equipment identification number.

4. The method according to claim 1, wherein the main equipment is a broadcast device.

5. The method according to claim 1, wherein the main equipment is a television set.

6. The method according to claim 1, wherein the main equipment is a cellular phone.

7. The method according to claim 1 wherein the activating methods include network activating methods and telephone activating methods.

8. The method according to claim 1 wherein the independent component functions normally upon successful verification of the activating code.

9. The method according to claim 1 wherein the independent component functions normally under the control of the control module upon successful verification of the activating code.

10. The method according to claim 1 wherein the control module instructs the main equipment to display an error message that re-prompts the user for the activating code upon unsuccessful verification of the activating code.

11. A device for activating independent software and hardware comprising:
a communication port of an independent software and hardware activating module for receiving activating guidance information of an independent component; and
a control module of the independent hardware and software activating module for generating cluing information according to the activating guidance information, and transmitting the cluing information to a main equipment,
the main equipment displaying the cluing information on a screen of the main equipment, and prompting a user to choose between activating methods to gain an activating code,
the user gaining the activating code according to a chosen activating method, and entering the activating code into the main equipment, the main equipment transmitting the activating code through the communication port to the control module for verification of the activating code.

12. The device according to claim 11, wherein the independent component is a signal receiving device.

13. The device according to claim 11 wherein the cluing information includes an equipment manufacturer and an equipment identification number.

14. The device according to claim 11, wherein the main equipment is a broadcast device.

15. The device according to claim 11, wherein the main equipment is a television set.

16. The device according to claim 11, wherein the main equipment is a cellular phone.

17. The device according to claim 11 wherein the activating methods include network activating methods and telephone activating methods.

18. The device according to claim 11 wherein the independent component functions normally upon successful verification of the activating code.

19. The device according to claim 11 wherein the independent component functions normally under the control of the control module upon successful verification of the activating code.

20. The device according to claim 11 wherein the control module instructs the main equipment to display an error message that re-prompts the user for the activating code upon unsuccessful verification of the activating code.
